(19) United States
(12) Patent Application Publication
(10) Pub. No.: US 2005/0020324 A1
(43) Pub. Date: Jan. 27, 2005

(54) Mobile phone

(76) Inventor: Eung-Soon Chang, Seoul (KR)

Correspondence Address: FISH & RICHARDSON PC, 225 FRANKLIN ST, BOSTON, MA, 02110, US

(21) Appl. No.: 10/885,203

(22) Filed: Jul. 6, 2004

(30) Foreign Application Priority Data
Jul. 3, 2003 (KR) 10-2003-0044990

(51) Int. Cl. H04M 1/00

(52) U.S. Cl. 455/575.1

(57) ABSTRACT

The present invention discloses a mobile phone for mobile communication which can excite the curiosity of consumers of all age groups by making a front case and a rear case vary in reflected colors according to the direction of light irradiation and the quantity of light, can increase the effect of preference for the corresponding product from a seller's point of view, and can avoid from getting bored even if used for a long time by increasing the attachment for the product from a user's point of view. The mobile phone comprises a main body case 20 provided with a front case 21 and a rear case 22, electronic parts stored therein and an antenna arranged in one side of the main body case 20, wherein the front case 21 and the rear case 22 are characterized in that entire or some parts of their respective exposed parts are made from a photosensitive resin so that their molecular structure is changed due to the effect of light to vary the color shown on the surface.

### BACKGROUND OF THE INVENTION

1. Field of the Invention

The present invention relates to a mobile phone, and more specifically to a mobile phone for mobile communication which can excite the curiosity of consumers of all age groups by making a main body of the mobile phone vary in reflected colors according to the direction of light irradiation and the quantity of light, can increase the marketability from a seller's point of view, and can improve the outward appearance of the mobile phone from a user's point of view.

2. Description of the Related Art

Generally, a mobile phone, which is one of mobile communication means, is one of communication apparatuses widely known to people, young and old, men and women all alike. In recent years, there have been introduced a lot of mobile phones of unique shape which are enhanced in functionality and whose appearance designs are improved in conformity with various tastes of all age groups.

Especially, teenagers and young people in their twenties and thirties are increasingly demanding more simple, unique and distinctive products. Thus, mobile phones of various novel shapes as well as mobile phones of various colors are being produced and delivered.

However, most of conventional mobile phones have been developed in shape and in a single color in improving the parts such as a main body, a cover, a key button, a liquid crystal display and so on, but they have not developed into such a type that is differently varied in color according to the direction of light irradiation.

Namely, as shown in FIG. 1, a mobile phone includes a main body case 10, electronic parts provided in this case, and an antenna 13 protruded on one side of the case 10.

As shown in FIG. 2, the main body case 10 consists of a front case 11 and a rear case 12. The front case 11 has a liquid crystal display unit 14 and a key button unit 15, and the rear case 12 has a battery assembly unit 16.

In most cases of the aforementioned conventional main body case 10, the front case 11 has a bright and elementary color. This makes it difficult to attract public gaze with a mysterious feeling, and the user would get easily bored with the case color and would lack the sustained attachment to possess the mobile phone for a long time.

### SUMMARY OF THE INVENTION

The present invention is designed in consideration of the problems of the prior art, and therefore it is an object of the present invention to provide a mobile phone for mobile communication which can excite the curiosity of consumers of all age groups by making a front case and a rear case vary in reflected colors according to the direction of light irradiation and the quantity of light, can increase the effect of preference for the corresponding product from a seller's point of view, and can avoid from getting bored even if used for a long time by increasing the attachment for the product from a user's point of view.

To achieve the above object, there is provided a mobile phone in accordance with characteristic configuration of the present invention, comprising a main body case provided with a front case and a rear case, electronic parts stored therein and an antenna arranged in one side of the main body case, wherein the front case and the rear case are characterized in that entire or some parts of their respective exposed parts are made from a photosensitive resin so that their molecular structure is changed due to the effect of light to vary the color shown on the surface.

### BRIEF DESCRIPTION OF THE DRAWINGS

Other objects and aspects of the present invention will become apparent from the following description of embodiments with reference to the accompanying drawings in which:

FIG. 1 is a perspective view showing a general mobile phone;

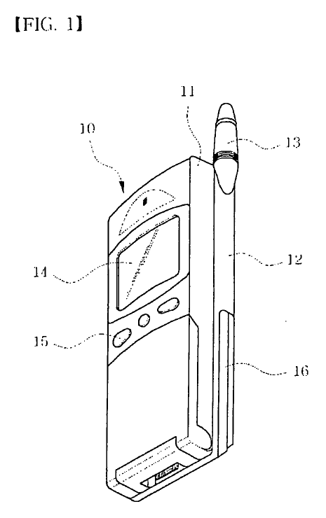

FIG. 2 is a perspective view showing a case of a mobile phone of the present invention;

FIG. 3 is a sectional view showing the case of the mobile phone of the present invention; and

FIG. 4 is a sectional view showing the configuration of another embodiment of the present invention.

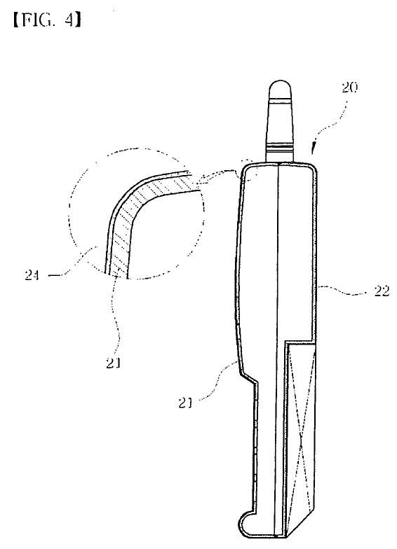

### DESCRIPTION OF THE PREFERRED EMBODIMENT

Hereinafter, a characteristic configuration of the present invention will be described in more detail referring to the drawings.

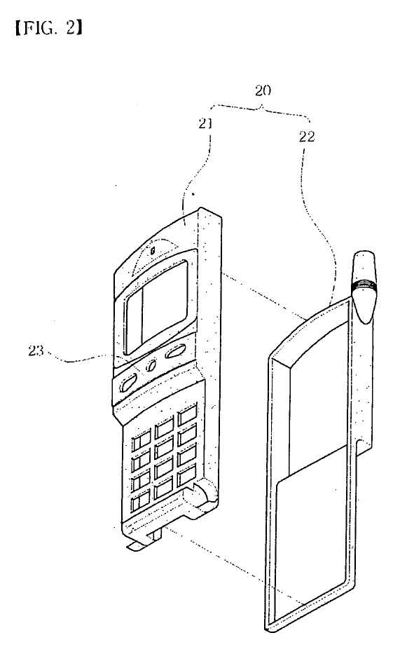

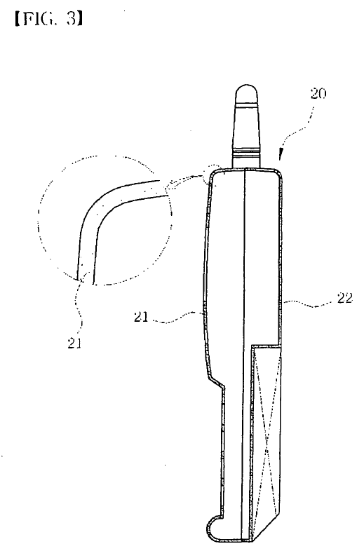

Firstly, FIG. 2 is a perspective view showing a mobile phone of the present invention, and FIG. 3 is a sectional view showing a case of the mobile phone of the present invention.

Recent mobile phones can be classified into a bar type exposing a button unit, a flip type covering some parts of a button unit and a folder type opened and shut by folding a liquid crystal display unit and a main body unit.

In whatever type, the main body case 20 comprises a front case 21 and a rear case 22. Exceptionally, in case of folder type, a liquid crystal display unit and a main body unit have their respective front and rear cases.

In the present invention, the front case 21 and rear case 22 of the main body case 20 are characterized in that some or entire parts exposed to the outside are made from a photosensitive resin so that their molecular structure is changed due to the effect of light to vary the color shown on the surface.

In the case of the front case 21, after forming a decorative unit 23 on exposed parts to enhance aesthetic appearance, the decorative unit 23 may be made of a photosensitive resin having a different color than the basic color of the front case 21.

In some cases, as shown in FIG. 3, a photosensitive coating layer 24 can be prepared by coating entire or some parts of the exposed parts with a photosensitive resin.

For reference, photosensitive resin is a synthetic resin (generally known as photopolymer) made of a photosensitive polymer that brings about a specific reaction (for example, variation in the bridging or color decomposition, etc.) upon receipt of light, and includes diazo resin, azide resin, lightly coated polyvinyl, acrylic resin, polyamide, polyester type and so forth.

These chemical compounds are changed in chemical structure when ultraviolet rays are irradiated from colors of a solution or solid state. According to the change, they have a different absorption spectrum and, thus, reflected colors are changed often and are reduced to their original state as soon as light is interrupted.

As described above in detail, in the mobile phone of the present invention, a front case and a rear case are made of a photosensitive resin which undergoes a chemical change so that reflected colors are varied according to the direction of light irradiation and the quantity of light. Thus, they are seen in various colors in a fluorescent light or in the sunlight, thereby being able to attract public gaze.

Consequently, the mobile phone of the present invention has merits that it is advantageous to the sale because of a high marketability from a seller's point of view, and it is possible to show one's individuality and increase the attachment to the product from a user's point of view to thereby make the user use the mobile phone for a long time because he or she is not bored even if used for a long time.

1. A mobile phone comprising a main body case provided with a front case and a rear case, electronic parts stored therein and an antenna arranged in one side of the main body case,
wherein the front case and the rear case are characterized in that entire or some parts of their respective exposed parts are made from a photosensitive resin so that their molecular structure is changed due to the effect of light to vary the color shown on the surface.

2. The mobile phone of claim 1, wherein a decorative unit is formed on exposed parts of the front case and then the decorative unit is made of a photosensitive resin having a different color than the color of the front case.

3. A mobile phone comprising a main body case provided with a front case and a rear case, electronic parts stored therein and an antenna arranged in one side of the main body case,
wherein the front case and the rear case are characterized in that entire or some parts of their respective exposed parts are made by forming a coating layer from a photosensitive resin so that their molecular structure is changed due to the effect of light to vary the color shown on the surface.
